(19) United States
(12) Patent Application Publication
(10) Pub. No.: US 2023/0086612 A1
(43) Pub. Date: Mar. 23, 2023

(54) DEEP INTELLIGENCE FOR DECENTRALIZED FINANCE

(71) Applicant: FORTIOR BLOCKCHAIN, LLLP, Sheridan, WY (US)

(72) Inventors: Brian Haney, Bellevue, WA (US); Archie Chaudhury, Peachtree City, GA (US)

(21) Appl. No.: 17/483,297

(22) Filed: Sep. 23, 2021

(51) Int. Cl. G06Q 30/02; G06N 3/08; H04L 9/08; H04L 9/30

(52) U.S. Cl. CPC G06Q 30/0283; G06N 3/08; H04L 9/088; H04L 9/30

(57) ABSTRACT

The disclosure is processes and devices for making predictions about decentralized asset pricing. Embodiments of the disclosure are comprised of three steps. First, data mining software aggregates a database from public blockchain data. Second, an artificial intelligence computer program cleans the database. Third, a deep learning algorithm processes the database to make predictions about the future price of decentralized assets.

### BACKGROUND TO THE INVENTION

The field of the disclosure rests at the intersection of two broader fields, artificial intelligence and blockchain. Blockchains are decentralized databases, maintained by distributed networks of computers. Artificial intelligence is a computer program replicating the thoughtful processes of the human mind. At the confluence of artificial intelligence and blockchain technologies, great opportunity for innovation is available. Converging two fields, the disclosure relates to software for a deep intelligence operating in decentralized financial markets for price predictions.

As an architecture, a blockchain is a distributed ledger which records transactions between parties. In other words, blockchain technology is an infrastructure for data storage and management. From a computational perspective, the programming language C++ is widely used for blockchain software development. However, other languages are used in development; for example, both Python and C support blockchain construction, with Python becoming far more frequently used recently. Indeed, various programming languages have evolved to facilitate both blockchain and AI development, including Python, C++, JavaScript.

Python is an interpreted programming language which commonly used for machine learning applications across industry. JavaScript is also an interpreted programming language which is more commonly used for web applications development. C++ is a machine-level language which is used for high performance computing that requires developers work close to the hardware. Given these various programming languages, the structure for the blockchain may be considered to have four parts: the network, the public-private key system, the transactional process, and mining.

A blockchain network consists of several computers, called nodes, which are connected via the Internet. Each node in the network maintains a transaction record called a ledger, which acts as a parasitic function of the Internet. The Internet has two fundamental layers, the Transmission Control Protocol (TCP), which manages packet assembly, and the Internet Protocol (IP) which passes packets from one computer to another. Blockchain networks like Bitcoin, Ethereum, and Algorand ultimately rely on both the TCP and IP to operate and can be viewed as application protocols, sitting on top of the transport layer.

Blockchains create a peer-to-peer network, which developed to solve the double spending problem, where the same digital coin is spent more than once. For example, some the Bitcoin protocol use timestamps and a proof-of-work to record a public history of transactions. The timestamp captures the time of transactions on the network, while the proof-of-work validates transactions. The idea is nodes consider the longest chain to be the correct one and will continue working to extend it. In other words, nodes validate the longest chain, which is the only chain that will continue to be extended. The means by which nodes transact is through a system of Public-Private Key Cryptography.

In short, PPKC enables encrypted messages to be sent without the need for a shared key. For example, one of the first PPKC systems was the Rivest-Shamir-Adleman (RSA) algorithm. The RSA algorithm creates a mathematically linked key pair by multiplying two prime numbers together. While, multiplying two prime numbers is computationally straightforward or relatively easy, figuring out which prime numbers were multiplied to get a number is computationally complex, making it possible to broadcast a public key while reserving a secure private key.

In a blockchain, the transactions are bundled into blocks. A block is a data structure, aggregating transactions for inclusion in a public ledger. Each block consists of a hash value from the previous block, which are transactions happening in the last ten minutes, and a random integer called a nonce. Each block is broadcast to the network, presenting a complex algorithmic problem for validation. Solving blocks on proof-of-work blockchains, like Bitcoin, typically requires an enormous amount of computation, but verifying the solution is relatively simple. As such, graphics processing units are the most popular hardware tool for blockchain technologies.

A financial transaction communicates to a network an authorized money movement has processed. The essential elements are a network of parties, an asset moved among those parties, and a process defining the procedures and obligations associated with the movement. In other words, transactions are data structures encoding the value transfer between participants in a system. While costly financial institutions have policed such transactions in the past, blockchain supports a network of traders to perform this function itself. As such, one of the most interesting aspects of blockchain technology is that a central authority does not need to verify transactions.

Algorand is a proof-of-stake blockchain, which evolved to improve security and power efficiency across the blockchain networks by limiting miners to validating transactions proportional to an ownership share. One problem Algorand solves is the majority override, a cryptographic hack which results from a competitive advantage in mining where one actor can control a majority of the nodes with more computing power. To combat the majority override problem, Algorand developed a proof-of-stake chain, differing from classical blockchains, which use a proof-of-work to validate transactions. Algorand also provides a democratic consensus mechanism for voting among nodes in its network.

The term artificial intelligence (AI) has been discussed at length by various scholars and industry leaders. Generally, AI refers to any machine capable of learning, remembering, and taking actions. AI technology is affecting industries across the economy including law, healthcare, and defense. AI automates tasks that were previously done manually, thus digitizing work and improving efficiency. For example, in the legal industry, technology assisted review is changing the discovery process. In other words, AI programs now complete tasks previously only lawyers could do, like classify documents based on relevancy during discovery. Finance is no exception, as the present disclosure relates to the convergence of artificial intelligence and pecuniary investment methods.

Broadly, AI is a field uniquely positioned at the intersection of several scientific disciplines including computer science, applied mathematics, and neuroscience. The AI design process is meticulous, deliberate, and time-consuming—involving intensive mathematical theory, data processing, and computer programming. All the while, AI's economic value is accelerating. One example of AI is deep learning, a process inspired by the neurological structures found in the human brain. Both artificial and biological neurons receive input from various sources and map input information to a single output value. Artificial neurons model the strength of synapses, the connectivity between neurons, with weight coefficients. Thus, neural information transfer in the biological brain inspires the way in which modern neural networks operate.

A deep learning system's model is the part of the system which learns and analyzes the data. The most common deep learning model is the deep neural network (DNN). A DNN is an organized structure of interconnected neurons. The network's interconnected neurons are modeled with weight coefficients, which are adjusted through a learning process until a model is optimized for performance. Typically, matrix multiplication and partial derivative calculations are the mathematical core for learning algorithms. Importantly, neural networks are universal function approximators, meaning they can approximate any function with desired accuracy. Since all information can be represented as numbers, the neural network's ability to generalize to new information is a critical component for deep learning. Consider theoretically a neural network can process any information.

Every neural network has an input layer and an output layer. And the depth of the model is defined by the number of hidden layers between the input and output layer. For example, a DNN contains many hidden layers between the input and output layer. The number of hidden layers may vary and is dependent on the particular model. Each layer of hidden neurons acts as a feature extractor by providing analysis of slightly more complicated features. The layers in a neural network are represented as a matrix, a rectangular array of numbers, symbols, or expressions, arranged in rows and columns. The mathematics for a forward pass—input to output— in a neural network is matrix multiplication.

But for machines to learn, there must be a way in which matter evolves itself to iteratively improve performance. In other words, the machine must have a way of interacting with its environment that recursively self improves. Backpropagation is a training algorithm for updating the weights in a neural network, improving accuracy over time. In other words, backpropagation is how neural networks learn. Backpropagation evolved to train neural networks. By applying a temporal element to the learning process, backpropagation allows neural networks iteratively learn through time. Generally, a backpropagation algorithm has three steps: (1) an instance enters the network, flowing forward until the network generates a prediction; (2) the network's error for the prediction is calculated by comparison to the correct output; and (3) the error is propagated back through the network, updating the weights.

Technically, backpropagation's central task is training the deep learning program. Another way, backpropagation is a method for computing the partial derivatives of error functions in neural networks. The algorithm iterates through the network toward a set of weights producing a desirable result. After consistent iteration, the network converges, capturing a pattern and allowing the network to generalize about new instances, rather than merely memorizing training data. The keystone to deep learning technologies, backpropagation remains a foundational achievement in AI studies because it enables machines to learn from the data they perceive.

Convolutional Neural Networks (CNNs) are a specific type of neural network used for deep learning in computer vision tasks. A CNN contains at least one convolution layer; a layer whose parameters are learnable kernels. Each kernel is convolved across an input matrix and the resulting output is called a feature map. CNNs are used for a variety of computer vision tasks, including object classification, image recognition, and action detection. The full output of the layers is obtained by stacking all of the feature maps to create dimensionality.

Reinforcement learning software optimizes agent performance according to a reward. The process involves building models and developing systems for decision making embedded in software programs. In practice, engineering reinforcement learning systems is a meticulous, time consuming, and data-intensive task process. But the effort is worthwhile because reinforcement learning learns without supervision. Reinforcement learning software contain three elements a: (1) model: the description of the agent-environment relationship; (2) reward: the agent's goal; and (3) policy: the decision function.

Innovation continues to spawn at the intersections of deep learning and reinforcement learning. Deep reinforcement learning is a new type of machine learning resulting from the technical convergence of two more mature machine learning methods, deep learning and reinforcement learning. The algorithms underlying the technology are capable of taking in information from their environment and achieving goals, representing the integration of machine intelligence and perception technologies. Deep reinforcement learning systems have three capabilities that set them apart from all previous systems: (1) generalization; (2) learning; and (3) intelligence.

At the intersection of AI and blockchain, great financial opportunity is flourishing with a problem-oriented approach to reducing risk in decentralized markets. The Efficient Market Hypothesis (EMH) suggests that the day-to-day price of financial assets is random. In other words, according to the EMH, the future price of financial assets cannot be predicted with any sort of certainty. However, recent advancements in machine learning technology call this hypothesis to question. Moreover, at a more fundamental level, the EMH is incorrect with respect to basic volatility predictions. For example, the price of a stock tomorrow is at least in part, determined by its price today. If a stock is $100.00 today, it is unlikely the stock would sell at $1.00 or $1,000.00 the following day. Moreover, it is likely the if the stock sells at $100.00 today that tomorrow it would sell within a range of $90.00 to $110.00—allowing a 10.00% variance which is considered highly volatile. So, market assets aren't completely random and there are statistical bounds for probabilistic pecuniary and pricing predictions.

Yet, for some investing in cryptocurrencies and other digital assets often comes with high risk due to the innate volatility present in the underlying markets. With high risk comes high reward for some, while other investors may suffer substantial financial loss. Many institutionalized investment firms are refraining from offering digital asset services to customers due to what they perceive as minimal regulatory guidance. As such, investors wishing to allocate capital to digital assets such as cryptocurrencies and NFTs are limited to online exchanges and wallets. However, investing and holding these assets through the existing methods causes some independent investors to fall behind because of inefficient trading, a lack of reliable information, and a lack of security.

Still, in decentralized markets the price volatility of assets may be extremely high. As a result, investors may lose as much as 47.00% of their investment in a single week. This creates uncertainty for investors, as well as risks for the cryptocurrency market as sudden swings can have detrimental impacts for decentralized economic ecosystems. One reason for the volatility is a lack of institutional strength and adoption compared to fiat currencies such as the United States Dollar or the Singapore Dollar for most digital assets. Additionally, market speculators and large index holders often induce artificial trading activity to inflate markets beyond their rightful value.

Moreover, in traditional investment funds, security and governance are centralized with hierarchical authority. For example, investment funds are typically controlled by a small team of institutional decision makers. However, this decision-making framework limits openness for global community development and collaboration, as well as the personal autonomy of network participants. All the while, investors who primarily barter through cryptocurrencies lack a secure source to store their assets while being guaranteed moderate growth. As such, individuals trading in digital assets often suffer from instant volatility issues that plague the blockchain community.

Thus, there exists a need for a way to stabilize the price of decentralized assets and financial forecasting is the keystone to enabling stability. Thus, the problem this disclosure solves is the decentralized asset volatility problem, which is defined as the innate and large variance in the price of cryptocurrencies compared to traditional financial assets, such as stocks, securities, and currencies. The decentralized asset volatility problem is particularly prevalent in the early part of the pecuniary process for new assets. As such, the present disclosure offers a scalable solution, which is heterogeneous and adaptable to different decentralized assets, improving investor decision making, reducing risk, and stabilizing the digital marketplace.

### SUMMARY

The problem this disclosure solves is the decentralized asset volatility problem, which is defined as the innate and large variance in the price of cryptocurrencies compared to traditional financial assets, such as stocks, securities, and currencies. The advantage of the current disclosure is to provide more accurate and narrow price predictions based on the specific and problem directed applications of artificial intelligence technologies, including deep learning.

In certain embodiments, the disclosure is a process and device for making predictions about the future price of decentralized assets. The software embedded device begins by data mining and aggregating a database. Second, an artificial intelligence computer program cleans the database to allow post-processing for predictive purposes. Finally, a deep intelligence software program processes the database to produce accurate predictions about the future price of decentralized assets.

In certain embodiments, the disclosure is a method for predicting the future price of decentralized assets. In such embodiments, the method comprises mining data relating to usage for blockchain networks using an autonomous web-scraping software. Additionally, the method may include processing data to a database file format and moving the data to a central database. The method may further include a software program preprocessing and cleaning the incoming data. Finally, a deep neural network may process the database, producing predictions relating to the predicted future price of digital assets.

In certain embodiments, the disclosure is a computing device including a processor in communication with a database. In such embodiments, the processor may be configured to mine data relating to usage for blockchain networks using an autonomous web-scraping software. A deep neural network is trained based on the mined data and configured to generate a predicted future price of digital assets based on usage of blockchain networks. Further, the processor may be configured to clean the mined data stored in the database file using artificial intelligence technologies to generate cleaned data in the database file. Lastly, the processor may be configured to generate, using the deep neural network, based on the cleaned data in the database file, predictions relating to the predicted future price of digital assets.

### BRIEF DESCRIPTION OF THE DRAWINGS

FIG. 1 illustrates embodiments of the present invention as an information flow model for financial forecasting.

FIG. 2 illustrates embodiments of the present invention as an information flow model for making predictions using cloud computing resources and a neural network architecture.

FIG. 3 illustrates embodiments of the present disclosure as a process including financial asset pricing and transaction data.

FIG. 4 illustrates embodiments of the present disclosure as a device for aggregating, processing, and storing data.

FIG. 5 illustrates embodiments of the present disclosure as a process for predicting the price of Algo, the Algorand cryptocurrency.

FIG. 6 illustrates embodiments of the present disclosure as a process for predicting the price of Bitcoin.

### DETAILED DESCRIPTION OF THE INVENTION

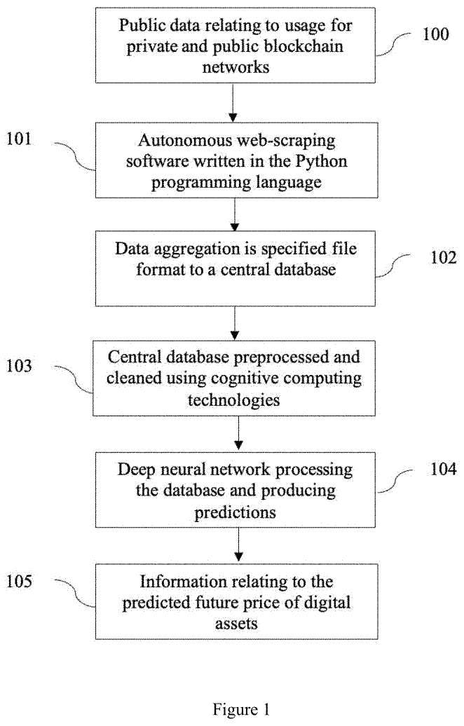

FIG. 1 illustrates embodiments of the present disclosure as an information flow model including public data relating to usage for private and public blockchain networks 100; autonomous web-scraping software written in the Python programming language 101; data aggregation is specified file format to a central database 102; central database preprocessed and cleaned using cognitive computing technologies 103; deep neural network processing the database and producing predictions 104; and information relating to the predicted future price of digital assets 105.

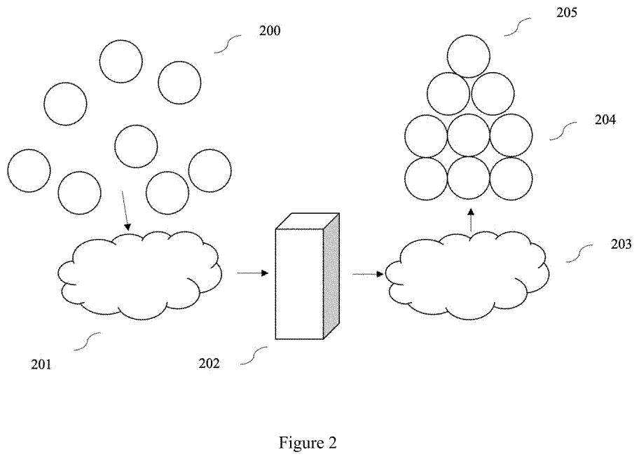

FIG. 2 illustrates embodiments of the present disclosure as an information flow model including unstructured data 200; which is aggregated via cloud resources 201; and processed in a centralized database 202; and then further processed with cloud computing resources 203; using a neural network 204; to produce predictions about the price of decentralized financial assets 205.

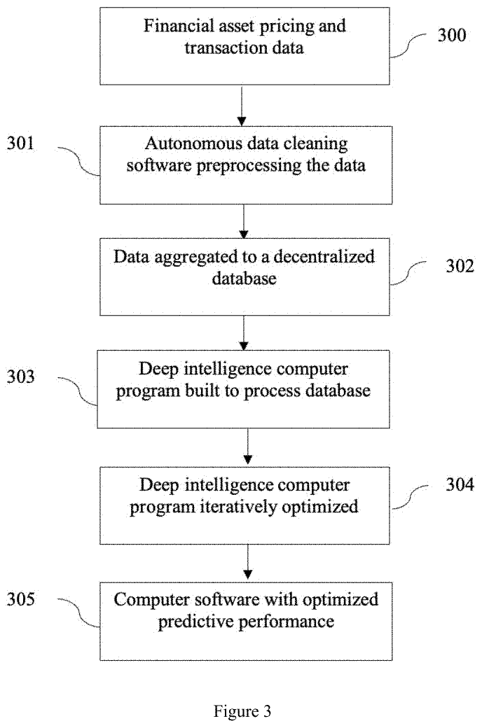

FIG. 3 illustrates embodiments of the present disclosure as a process including financial asset pricing and transaction data 300; autonomous data cleaning software preprocessing the data 301; data aggregated to a decentralized database 302; deep intelligence computer program built to process database 303; deep intelligence computer program iteratively optimized 304; and a computer software with optimized predictive performance 305.

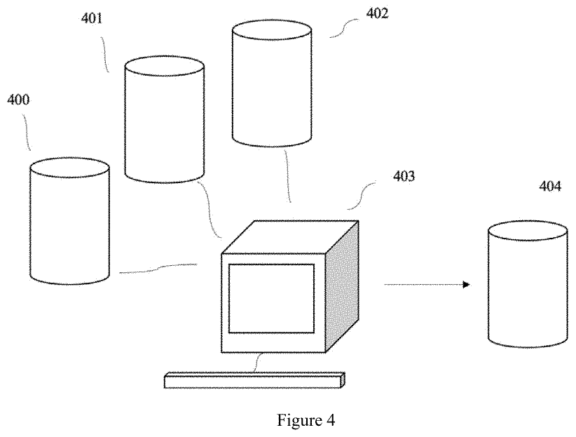

FIG. 4 illustrates embodiments of the present disclosure including a device 403 for aggregating, processing, and storing data; wherein unstructured data silos 400, 401, and 402 are aggregated and processed with a personal computing device 403; for predictive purposes and the predictions are stored in a structure database 404.

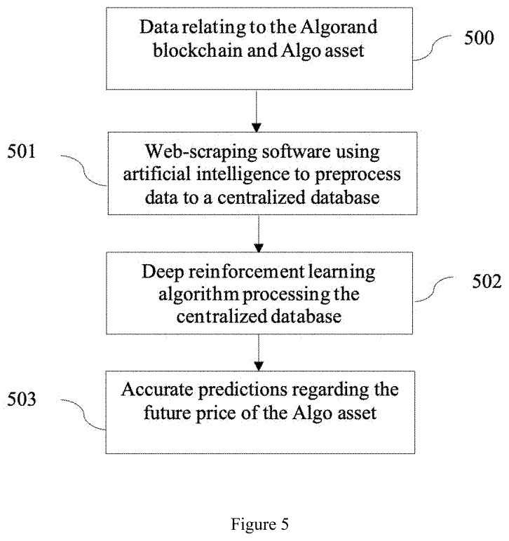

FIG. 5 illustrates embodiments of the present disclosure as a process for predicting the price of Algo, the Algorand cryptocurrency. First, data relating to the Algorand blockchain and Algo asset 500 is targeted for acquisition. Next, web-scraping software collects the targeted data, using artificial intelligence to preprocess data to a centralized database 501. Then, a deep reinforcement learning program processes the clean centralized database 502. Finally, the deep reinforcement learning software produces accurate predictions regarding the future price of the Algo asset 503.

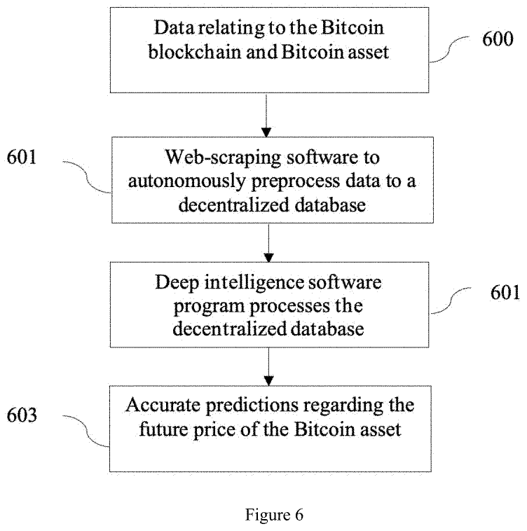

FIG. 6 illustrates embodiments of the present disclosure as a process for predicting the price of Bitcoin. First, data relating to the Bitcoin blockchain and Bitcoin asset are identified for data mining 600. Next, a web-scraping software autonomously preprocess data to a decentralized database 601. Then a trained deep intelligence software program processes the decentralized database 602. Finally, the deep intelligence software produces accurate predictions regarding the future price of the Bitcoin asset 603.

In certain embodiments of the disclose, the disclosure is a method for predicting the future price of decentralized assets. In such embodiments, the method comprises mining public data on the Internet relating to usage for private and public blockchain networks, which is deployed via an autonomous web-scraping software written in the Python programming language. The software specifies and executes data aggregation functions, downloading information in a database file format to a database. In turn, the database cleans the incoming data using artificial intelligence technologies, which are formalized in an autonomous software computer program. The autonomous software computer program includes a deep neural network, which processes the database and produces predictions. The predictions relate to the future of a cryptocurrency, such as Algo, the Algorand cryptocurrency 503, or Bitcoin 603.

In certain embodiments of the disclosure, the disclosed methods include information transfer methods which utilize one or more single layer neural networks. The neural networks may be used for several purposes among certain embodiments including adding price prediction processes.

$${x}_{l} \to {x}_{l + 1} \begin{matrix} \\ \to \end{matrix} \\ {x}_{p} \to {x}_{p + 1} \begin{matrix} \\ \to \end{matrix} {x}^{°} \\ {x}_{a} \to {x}_{a + 1} \qquad ( 1 )$$

$${x}_{a + 1} ← {x}_{a} \\ {x}^{°} \begin{matrix}← \\ \end{matrix} {x}_{p + 1} ← {x}_{p} \\ \begin{matrix}← \\ \end{matrix} {x}_{l + 1} ← {x}_{l} \qquad ( 2 )$$

$$\begin{matrix}{x}_{a} \to {x}_{a + 1} \begin{matrix} \\ \to \end{matrix} & & \begin{matrix} \\ ←\end{matrix} {x}_{l + 1} ← {x}_{l} \\ {x}_{p} \to {x}_{p + 1} \begin{matrix} \\ \to \end{matrix} {x}^{°} & {x}^{*} & {x}^{°} \begin{matrix} \\ ←\end{matrix} {x}_{p + 1} ← {x}_{p} \\ {x}_{l} \to {x}_{l + 1} & & {x}_{a + 1} ← {x}_{a}\end{matrix} \qquad ( 3 )$$

Equation 1 is an actor network for a single layer neural network. Equation 2 is a critic network for a single layer neural network. Equation 3 is dualling neural networks. The dualling derivative juxtaposes the actor against the critic, which transposes the actor to optimize the resulting output for accuracy.

In other embodiments of the disclosure, the disclosed methods include information transfer methods which utilize one or more linear neural networks. Linear neural networks utilize linear operators to predict price movements, generalizing from data using machine learning.

$${x}_{l} ⊕ {x}_{l + 1} \\ {x}_{p} ⊕ {x}_{p + 1} \begin{matrix}⊕ \\ ⊕\end{matrix} {x}^{°} \\ {x}_{a} ⊕ {x}_{a + 1} \qquad ( 4 )$$

$${x}_{a + 1} ⊕ {x}_{a} \\ {x}^{°} \begin{matrix}⊕ \\ ⊕\end{matrix} {x}_{p + 1} ⊕ {x}_{p} \\ {x}_{l + 1} ⊕ {x}_{l} \qquad ( 5 )$$

$$\begin{matrix}{x}_{a} ⊕ {x}_{a + 1} & & {x}_{l + 1} ⊕ {x}_{l} \\ {x}_{p} ⊕ {x}_{p + 1} \begin{matrix}⊕ \\ ⊕\end{matrix} {x}^{°} & {x}^{*} & {x}^{°} \begin{matrix}⊕ \\ ⊕\end{matrix} {x}_{p + 1} ⊕ {x}_{p} \\ {x}_{l} ⊕ {x}_{l + 1} & & {x}_{a + 1} ⊕ {x}_{a}\end{matrix} \qquad ( 6 )$$

Equation 4 is an actor network for a linear neural network. Equation 5 is a critic network for a linear neural network. Equation 6 is dualling linear neural networks.

In embodiments of the disclosure, the disclosed methods include information transfer methods which utilize one or more nonlinear neural networks. Nonlinear neural network utilize nonlinear operators to predict price movements, generalizing from data using machine learning.

$${x}_{l} ⊗ {x}_{l + 1} \\ {x}_{p} ⊗ {x}_{p + 1} \begin{matrix}⊗ \\ ⊗\end{matrix} {x}^{°} \\ {x}_{a} ⊗ {x}_{a + 1} \qquad ( 7 )$$

$${x}_{a + 1} ⊗ {x}_{a} \\ {x}^{°} \begin{matrix}⊗ \\ ⊗\end{matrix} {x}_{p + 1} ⊗ {x}_{p} \\ {x}_{l + 1} ⊗ {x}_{l} \qquad ( 8 )$$

$$\begin{matrix}{x}_{a} ⊗ {x}_{a + 1} & & {x}_{l + 1} ⊗ {x}_{l} \\ {x}_{p} ⊗ {x}_{p + 1} \begin{matrix}⊗ \\ ⊗\end{matrix} {x}^{°} & {x}^{*} & {x}^{°} \begin{matrix}⊗ \\ ⊗\end{matrix} {x}_{p + 1} ⊗ {x}_{p} \\ {x}_{l} ⊗ {x}_{l + 1} & & {x}_{a + 1} ⊗ {x}_{a}\end{matrix} \qquad ( 9 )$$

Equation 7 is an actor network for a nonlinear neural network. Equation 8 is a critic network for a nonlinear neural network. Equation 9 is dualling nonlinear neural networks.

In embodiments of the disclosure, various partial derivative calculations may be used to update the neural networks weights through backpropagation. Backpropagation updates the weights for the neural network to optimize performance.

$$\frac{{\partial }^{2} {x}^{*}}{\partial {l}^{2}} + \frac{{\partial }^{2} {x}^{*}}{\partial {p}^{2}} + \frac{{\partial }^{2} {x}^{*}}{\partial {a}^{2}} = {min}_{{x}^{*}} {x}^{*} ( {x}_{i}^{°} - {x}_{j}^{°} ) \qquad ( 10 )$$

$$\frac{{\partial }^{2} {x}^{*}}{\partial {l}^{2}} + \frac{{\partial }^{2} {x}^{*}}{\partial {p}^{2}} + \frac{{\partial }^{2} {x}^{*}}{\partial {a}^{2}} = {min}_{{x}^{*}} {x}^{*} ( {x}_{j}^{°} - {x}_{i}^{°} ) \qquad ( 11 )$$

$$\frac{{\partial }^{2} {x}^{*}}{\partial {l}^{2}} + \frac{{\partial }^{2} {x}^{*}}{\partial {p}^{2}} + \frac{{\partial }^{2} {x}^{*}}{\partial {a}^{2}} = {min}_{{x}^{*}} {x}^{*} \vert {x}_{i}^{°} - {x}_{j}^{°} \vert \qquad ( 12 )$$

Equation 10 and Equation 11 are variations of partial differential equations. Equation 12 is an absolute form of Equation 10 and Equation 11. In certain embodiments, Equation 12 is used to optimize price predictions for Algo. In certain embodiments, Equation 12 is used to optimize price predictions for Bitcoin.

A commonly used backpropagation algorithm is the Chain Rule.

$${lim}_{Δ p \to 0} \frac{Δ a}{Δ p} = \frac{Δ a}{Δ l} = \frac{Δ a}{Δ l} \cdot \frac{Δ l}{Δ p} \qquad ( 13 )$$

$${lim}_{Δ p \to 0} \frac{Δ a}{Δ p} \qquad ( 14 )$$

In Equation 13, the Chain Rule is depicted, where a is a function of l and l is a function of p. The derivative of α with respect top is defined in Equation 14. In other words, the Chain Rule takes the dot product of the derivative of α with respect to l and the derivative of l with respect top. In certain embodiments, Equation 14 is used to compute the optimize price prediction mechanism for Algo.

Various formal models may be deployed to facilitate deep intelligence networks.

$$[ {x}_{l} {x}_{p} {x}_{a} ] ⊗ [ \begin{matrix}{x}_{l} \\ {x}_{p} \\ {x}_{a}\end{matrix} ] ⊕ [ \begin{matrix}{x}_{l} \\ {x}_{p} \\ {x}_{a}\end{matrix} ] ⊗ [ {x}_{l} {x}_{p} {x}_{a} ] \qquad ( 15 )$$

$$[ {x}_{l} {x}_{p} {x}_{a} ] ⊕ [ \begin{matrix}{x}_{l} \\ {x}_{p} \\ {x}_{a}\end{matrix} ] ⊗ [ \begin{matrix}{x}_{l} \\ {x}_{p} \\ {x}_{a}\end{matrix} ] ⊕ [ {x}_{l} {x}_{p} {x}_{a} ] \qquad ( 16 )$$

Equation 15 and Equation 16 are mathematical architectures for multilayer neural networks. The operators in Equation 15 and Equation 16 are switched to allow for both linear and nonlinear processing within the several layers of a neural network architecture. In certain embodiments, Equation 15 or its derivatives may be used to optimize price predictions for Algo. In other embodiments, Equation 16 or its derivatives may be used to optimize price predictions for Bitcoin.

Various formal models may be deployed to facilitate deep intelligence networks.

$$[ \begin{matrix}{x}_{l} \\ {x}_{p} \\ {x}_{a}\end{matrix} ] ⊗ [ \begin{matrix}{x}_{l} \\ {x}_{p} \\ {x}_{a}\end{matrix} ] ⊗ [ \begin{matrix}{x}_{l} \\ {x}_{p} \\ {x}_{a}\end{matrix} ] ⊕ [ {x}_{l} {x}_{p} {x}_{a} ] ⊕ [ \begin{matrix}{x}_{l} \\ {x}_{p} \\ {x}_{a}\end{matrix} ] ⊗ [ \begin{matrix}{x}_{l} \\ {x}_{p} \\ {x}_{a}\end{matrix} ] ⊗ [ \begin{matrix}{x}_{l} \\ {x}_{p} \\ {x}_{a}\end{matrix} ] \qquad ( 17 )$$

$$[ \begin{matrix}{x}_{l} \\ {x}_{p} \\ {x}_{a}\end{matrix} ] ⊕ [ \begin{matrix}{x}_{l} \\ {x}_{p} \\ {x}_{a}\end{matrix} ] ⊕ [ \begin{matrix}{x}_{l} \\ {x}_{p} \\ {x}_{a}\end{matrix} ] ⊗ [ {x}_{l} {x}_{p} {x}_{a} ] ⊗ [ \begin{matrix}{x}_{l} \\ {x}_{p} \\ {x}_{a}\end{matrix} ] ⊕ [ \begin{matrix}{x}_{l} \\ {x}_{p} \\ {x}_{a}\end{matrix} ] ⊕ [ \begin{matrix}{x}_{l} \\ {x}_{p} \\ {x}_{a}\end{matrix} ] \qquad ( 18 )$$

Equation 17 and Equation 18 are mathematical architectures for deep neural networks with multiple processing layers. The operators in Equation 17 and Equation 18 are switched to allow for both linear and nonlinear processing within the several layers of a neural network architecture. In certain embodiments, Equation 17 is used to optimize price predictions for Algo. In other embodiments, Equation 18 is used to optimize price predictions for Bitcoin.

Various formal models may be deployed to facilitate deep intelligence networks.

$$[ \begin{matrix}{x}_{l} \\ {x}_{p} \\ {x}_{a}\end{matrix} ] ⊕ [ \begin{matrix}{x}_{l} \\ {x}_{p} \\ {x}_{a}\end{matrix} ] ⊕ [ \begin{matrix}{x}_{l} \\ {x}_{p} \\ {x}_{a}\end{matrix} ] ⊗ [ {x}_{l} {x}_{p} {x}_{a} ] ⊗ [ {x}_{l} {x}_{p} {x}_{a} ] … \qquad ( 19 )$$

$$… [ {x}_{l} {x}_{p} {x}_{a} ] ⊗ [ {x}_{l} {x}_{p} {x}_{a} ] ⊗ [ \begin{matrix}{x}_{l} \\ {x}_{p} \\ {x}_{a}\end{matrix} ] ⊕ [ \begin{matrix}{x}_{l} \\ {x}_{p} \\ {x}_{a}\end{matrix} ] ⊕ [ \begin{matrix}{x}_{l} \\ {x}_{p} \\ {x}_{a}\end{matrix} ] \qquad ( 20 )$$

Equation 19 and Equation 20 are models from an elongated neural network with both convolutional and recurrent layers. The elongated neural network represents evolution of sequential time series, which begins in Equation 19 and concludes in Equation 20. In certain embodiments, Equation 19 and Equation 20 are used to optimize price predictions for Algo.

In certain embodiments of the disclosure, applied to blockchains and decentralized assets, deep reinforcement learning algorithms may process asset data 100 and generalize using a neural network 204 to predict the future price of assets 205. In turn, the neural network 204 may learn from their decisions 205 about whether their predictions were right or wrong. Moreover, the neural network 204 may engage in goal-oriented behavior, such as to maximize the value of a portfolio of assets 305.

In certain embodiments, the disclosure is a process and device for making predictions about decentralized asset pricing, which may include three steps. First, in step one, a data mining software aggregates a database using autonomous mining techniques for processing both unstructured and structured data. Second, an artificial intelligence computer program, which is embodied in formalized rules and computational logic, cleans the database. Third, a deep learning algorithm 204, which has been trained on data 100 using machine learning, processes the database to make predictions about the price of Algo 503.

In certain embodiments, the disclosure is a computing device for predicting the future price of decentralized assets. The device comprising a software structure mining public data relating to usage for blockchain networks; an autonomous web-scraping software written in the Python programming language; specifying data aggregation in a database file format to a central database; the central database preprocessing and cleaning the incoming data using cognitive computing technologies; a deep neural network processing the database and producing predictions 104; producing information relating to the predicted future price of digital assets 105.

In certain embodiments, the disclosure is a software for predicting price and trading decentralized assets using deep reinforcement learning. In such embodiments, neural network software is integrated within a reinforcement learning architecture for a general intelligence technique, which is applied to predict prices for decentralized financial assets. Deep reinforcement learning systems have three capabilities that set them apart from all previous systems: (1) generalization; (2) learning; and (3) intelligence. In such embodiments, the intelligence is a goal-oriented software program for maximizing the value of a decentralized asset portfolio, which is applied for trading decentralized assets.

In certain embodiments of the disclosure, the disclosure is a process comprised of three steps. First, data mining software aggregates a database from public blockchain data 404. Second, an artificial intelligence computer program 501 cleans the database 102. Third, a deep learning algorithm 602 processes the database 304 to make predictions about the future price Bitcoin 603.

In certain embodiments of the disclosure, the disclosure is a computing device for predicting the future price of decentralized assets, the computing device comprising at least one processor and at least one memory device. Graphics processing units are used to facilitate high performance computing, offering better efficiency than conventional computer chips. In such embodiments, the processor may be configured to store: a software structure mining public data relating to usage for blockchain networks; an autonomous web-scraping software written in the Python programming language, specifying data aggregation in a database file format to a central database. Moreover, the central database preprocesses and cleans the incoming data using artificial intelligence technologies and a deep neural network processes the database and produces predictions with information relating to the predicted future price of digital assets.

In certain embodiments, the present disclosure is a process for predicting the future price of decentralized financial assets. The process includes public data relating to usage for private and public blockchain networks 100 and an autonomous web-scraping software written in the Python programming language 101. The data are aggregated and specified using a database file format to a central database 102. The, the central database is preprocessed and cleaned using cognitive computing technologies 103, before a deep neural network processes the database and producing predictions 104. The result, or software output, is instructions and information relating to the predicted future price of digital assets 105, such as Algorand 503 and Bitcoin 603.

In certain embodiments, the present disclosure is a process for predicting prices of cryptocurrencies. The process begins with unstructured data 200, which is aggregated via cloud resources 201. Next, the data is processed and aggregated to a centralized database 202. Then, further processed with cloud computing resources 203; using a neural network 204. Finally, the neural network produces predictions about the price of decentralized financial assets 205.

In certain embodiments, the present disclosure is a process including financial asset pricing and transaction data 300. Next, an autonomous data cleaning software preprocessing the data is deployed to facilitate cleaning 301. In turn, the software aggregates the data to a decentralized database 302. Then, a deep intelligence computer program processes the database 303 and the deep intelligence computer program is iteratively optimized 304. Over time, the computer software achieves optimized predictive performance 305.

In certain embodiments of the present disclosure, the disclosure includes a device 403 for aggregating, processing, and storing data. The device targets unstructured data silos 400, 401, and 402 are aggregates and processes the data using a personal computing device 403. The personal computing device uses a deep intelligence computer program including one or more neural networks for predictive purposes and the predictions of the deep intelligence computer program are stored in a structure database 404.

In certain embodiments of the present disclosure, the disclosure is a device 403 for aggregating, processing, and storing data; wherein unstructured data 200 are aggregated and processed with a personal computing device 403, which uses a deep intelligence computer program including one or more neural networks 204 for predictive purposes. In such embodiments, the predictions of the deep intelligence computer program 205, may be stored in a stored in a structure database 404 and used to inform intelligent software decision making 305.

In certain embodiments of the present disclosure, the disclosure is a process for predicting the future price of decentralized assets 205. Blockchain data 100 are aggregated and processed with a personal computing device 403, using a deep learning computer program including one or more neural networks 204 for predictive purposes. In such embodiments, the predictions of the deep learning computer program 205 may be used to inform intelligent software decision making 305.

In certain embodiments, the disclosure is a process and device for making predictions about the future price of decentralized assets. The software embedded device begins by data mining and aggregating a database 404. Second, an artificial intelligence computer program cleans the database to allow post-processing for predictive purposes 501. Finally, a deep intelligence software program processes the database to produce accurate predictions about the future price of decentralized assets.

In certain embodiments, the disclosure is a method for predicting a price of decentralized assets. The method may be performed by a computing device including a processor in communication with a database. The method may further comprise mining, by the processor, historical data relating to usage for blockchain networks using an autonomous web-scraping software. Additionally, the method may include training, by the processor, a deep neural network based on the mined data, the deep neural network configured to generate a predicted future price of digital assets based on usage of blockchain networks and mining, by the processor, further data relating to usage for blockchain networks using an autonomous web-scraping software. Moreover, the method may include generating a database file having a database file format based on the mined further data and storing the database file in a central database. And the method includes cleaning the mined data stored in the database file using artificial intelligence technologies to generate cleaned data in the database file. Finally, the method may include generating, by the processor using the deep neural network, based on the cleaned data in the database file, predictions relating to the predicted future price of digital assets.

In certain embodiments, the disclosure is a method for predicting the future price of decentralized assets. In such embodiments, the method may comprise mining public data relating to usage for blockchain networks; an autonomous web-scraping software written in the Python programming language. Additionally, the method may include processing data to a database file format and moving the data to a central database. The method may further include a software program preprocessing and cleaning the incoming data. Finally, a deep neural network may process the database, producing predictions; the predictions relating to the predicted future price of digital assets.

In certain embodiments, the disclosure is a computing device including a processor in communication with a database. In such embodiments, the processor may be configured to: mine historical data relating to usage for blockchain networks using an autonomous web-scraping software and train a deep neural network based on the mined data, the deep neural network configured to generate a predicted future price of digital assets based on usage of blockchain networks. Additionally, the processor may be configured to mine further data relating to usage for blockchain networks using an autonomous web-scraping software and generate a database file having a database file format based on the mined further data, as well as store the database file in a central database. Further, the processor may be configured to clean the mined further data stored in the database file using artificial intelligence technologies to generate cleaned data in the database file. Lastly, the processor may be configured to generate, using the deep neural network, based on the cleaned data in the database file, predictions relating to the predicted future price of digital assets.

It is to be understood that while certain embodiments and examples of the invention are illustrated herein, the invention is not limited to the specific embodiments or forms described and set forth herein. It will be apparent to those skilled in the art that various changes and substitutions may be made without departing from the scope or spirit of the invention and the invention is not considered to be limited to what is shown and described in the specification and the embodiments and examples that are set forth therein. Moreover, several details describing structures and processes that are well-known to those skilled in the art and often associated with blockchain and artificial intelligence technologies are not set forth in the following description to better focus on the various embodiments and novel features of the disclosure of the present invention. One skilled in the art would readily appreciate that such structures and processes are at least inherently in the invention and in the specific embodiments and examples set forth herein.

One skilled in the art will readily appreciate that the present invention is well adapted to carry out the objectives and obtain the ends and advantages mentioned herein as well as those that are inherent in the invention and in the specific embodiments and examples set forth herein. The embodiments, examples, methods, and compositions described or set forth herein are representative of certain preferred embodiments and are intended to be exemplary and not limitations on the scope of the invention. Those skilled in the art will understand that changes to the embodiments, examples, methods and uses set forth herein may be made that will still be encompassed within the scope and spirit of the invention. Indeed, various embodiments and modifications of the described compositions and methods herein which are obvious to those skilled in the art, are intended to be within the scope of the invention disclosed herein. Moreover, although the embodiments of the present invention are described in reference to use in connection with blockchain and artificial intelligence technology, ones of ordinary skill in the art will understand that the principles of the present inventions could be applied to other types of computers for a wide variety of applications.

We claim:

1. A method for predicting a price of decentralized assets, the method performed by a computing device including a processor in communication with a database, the method comprising: mining, by the processor, historical data relating to usage for blockchain networks using an autonomous web-scraping software; training, by the processor, a deep neural network based on the mined data, the deep neural network configured to generate a predicted future price of digital assets based on usage of blockchain networks; mining, by the processor, further data relating to usage for blockchain networks using an autonomous web-scraping software; generating, by the processor, a database file having a database file format based on the mined further data; storing, by the processor, the database file in a central database; cleaning, by the processor, the mined further data stored in the database file using artificial intelligence technologies to generate cleaned data in the database file; and generating, by the processor using the deep neural network, based on the cleaned data in the database file, predictions relating to the predicted future price of digital assets.

2. The method of claim 1, wherein the autonomous web scraping software is written in one of a Python programming language or a JavaScript programming language.

3. The method of claim 1, wherein the generated predictions relate to a price of Bitcoin, and wherein the method further comprises computing an optimized point to purchase an asset based on the generated predictions.

4. The method of claim 1, wherein the generated predictions relate to a price of Algo, and wherein the method further comprises computing an optimized point to purchase an asset based on the generated predictions.

5. The method of claim 1, wherein the historical data and further data relating to usage for blockchain networks includes data relating to proof-of-stake blockchains.

6. The method of claim 1, wherein the historical data and the further data relating to usage for blockchain networks includes data relating to proof-of-work blockchains.

7. The method of claim 1, wherein the processor includes a graphics processing unit.

8. A computing device including a processor in communication with a database, the processor configured to: mine historical data relating to usage for blockchain networks using an autonomous web-scraping software; train a deep neural network based on the mined data, the deep neural network configured to generate a predicted future price of digital assets based on usage of blockchain networks; mine further data relating to usage for blockchain networks using an autonomous web-scraping software; generate a database file having a database file format based on the mined data; and storing the database file in a central database; clean the mined data stored in the database file using artificial intelligence technologies to generate cleaned data in the database file; and generate, using the deep neural network, based on the cleaned data in the database file, predictions relating to the predicted future price of digital assets.

9. The computing device of claim 8, wherein the autonomous web scraping software is written in one of a Python programming language or a JavaScript programming language.

10. The computing device of claim 8, wherein the generated predictions relate to a price of Bitcoin, and wherein the processor is further configured to compute an optimized point to purchase an asset based on the generated predictions.

11. The computing device of claim 8, wherein the generated predictions relate to a price of Algo, and wherein the processor is further configured to compute an optimized point to purchase an asset based on the generated predictions.

12. The computing device of claim 8, wherein the historical data and further data relating to usage for blockchain networks includes data relating to proof-of-stake blockchains.

13. The computing device of claim 8, wherein the historical data and the further data relating to usage for blockchain networks includes data relating to proof-of-work blockchains.

14. The computing device of claim 8, wherein the processor includes a graphics processing unit.

15. A method for predicting the future price of decentralized assets, the method comprising mining public data relating to blockchain networks; using an autonomous web-scraping software written in the Python programming language; cleaning the public data; sending the cleaned public data to a central database; using a software program preprocessing and cleaning the incoming data; applying a deep neural network processing the central database and producing predictions produced by a deep neural network; relating to a predicted future price of digital assets.

16. The method of claim 15, wherein the web scraping software is written in the JavaScript programming language.

17. The method of claim 15, wherein the predictions relating to the predicted future price of digital assets relate to the price of Bitcoin, wherein a second software program processes the predictions to return an optimized point to purchase the asset.

18. The method of claim 15, wherein the predictions relating to the predicted future price of digital assets relate to the price of Algo, wherein a second software program processes the predictions to return an optimized point to purchase the asset.

19. The method of claim 15, wherein the deep neural network processing the database and producing predictions, aligns with a second deep neural network processing the database and producing predictions, wherein a third artificial intelligence function minimizes the difference between the two deep neural networks, using the data to inform a software which makes decisions regarding the most likely prediction.

20. The method of claim 15, wherein the deep neural network processing the database and producing predictions feeds the predictions to a reinforcement learning software taking actions, using the predictions, produced by the deep neural network, to inform intelligent decision making for asset allocation.
